(19) United States
(12) Patent Application Publication
(10) Pub. No.: US 2014/0064539 A1
(43) Pub. Date: Mar. 6, 2014

(54) VIBRATION-REDUCING PASSIVE RADIATORS

(71) Applicants: Christopher J. Link, Arlington, MA (US); Hal Greenberger, Natick, MA (US)

(72) Inventors: Christopher J. Link, Arlington, MA (US); Hal Greenberger, Natick, MA (US)

(21) Appl. No.: 13/600,316

(22) Filed: Aug. 31, 2012

(51) Int. Cl. G10K 13/00; H04R 1/20; H04R 1/02

(52) U.S. Cl. 381/345; 181/148

(57) ABSTRACT

An audio system includes a passive radiator that is attached to one end of a lever arm. The other end of the lever arm is attached to a mass that serves to move out of phase of the passive radiator to cancel mechanical vibrations of the passive radiator, but without significantly affecting audio output. The lever arm is attached to a mechanical ground, which may be the enclosure on which the passive radiator is mounted. A system may use multiple lever arms to reduce rocking of the passive radiator.

### BACKGROUND

This disclosure generally relates to structures for passively radiating sound waves, typically sound wave for reproducing low frequency audio (or bass). For background, reference is made to the pending application Ser. No. 12/751,352 filed on Mar. 31, 2010, for MOVING MAGNET LEVERED LOUDSPEAKER, the entire disclosure of which is hereby incorporated by reference.

### SUMMARY

In one aspect, an audio system uses at least one lever arm assemblies to mass balance a passive radiator. Multiple lever arm assemblies may also be used to mass balance a passive radiator. In addition, multiple lever arm assemblies may be arranged around the passive radiator such that they also reduce rocking modes of the passive radiator, and may be configured to essentially torque balance the passive radiator. Each lever arm assembly includes a fulcrum fixed to a mechanical ground, a lever arm attached the passive radiator on one side of the fulcrum and a counterbalance mass attached on the other side of the fulcrum.

In another aspect, an audio system includes an enclosure enclosing a volume of air, a passive radiator mounted to the enclosure and in fluid communication with the volume of air, a fulcrum fixed to a mechanical ground, and a lever arm attached to the passive radiator on a first side of the fulcrum and a mass coupled to it on a second side of the fulcrum. With this arrangement, the lever arm and its mass move with the passive radiator such that it reduces a level of vibration transmitted to the mechanical ground caused by movement of the passive radiator, when compared with the level of vibration transmitted to the mechanical ground by movement of the passive radiator without the operation of the lever arm and its mass.

In some implementations, the mechanical ground may be the enclosure of the audio system. Also, multiple lever arms may be used to reduce the level of vibration transmitted to the mechanical ground by the passive radiator. In addition, multiple lever arms may be arranged to provide a greater resistance to rocking by the passive radiator when compared with the passive radiator without operation of the lever arms and their masses. The fulcrum of the lever arms may be attached to the same enclosure wall as the passive radiator, or a different call (such as wall adjacent to or opposite of the wall on which the passive radiator is mounted). The system may include one or more transducers that are in fluid communication with the volume of air, and, if two (or more) transducers are used, they may be mounted such that their acoustic energy adds while their mechanical vibrations into the enclosure subtract. The lever arm may be attached to the passive radiator with a coupling that allows for the simultaneous linear movement of the passive radiator and actuate movement of the passive radiator. This coupling may be a compliant coupling.

In another aspect, an audio system includes an enclosure enclosing a volume of air, a passive radiator, and a plurality of lever arms coupled to the passive radiator at a first end of each lever arm. Each lever arm is further pivotally attached to a fulcrum and each fulcrum is attached to a mechanical ground. Each lever arm also includes a mass on the side of the fulcrum opposed the side on which the lever arm is attached to the passive radiator such that the lever arms move the masses out of phase with movement of the passive radiator.

In some implementations, the plurality of lever arms may be arranged to torque balance the passive radiator. The plurality of lever arms may be attached symmetrically around a surface of the passive radiator. The plurality of lever arms may be arranged to provide a greater resistance to rocking by the passive radiator when compared with the passive radiator without operation of the lever arms and their masses. The fulcrum of the lever arms may be attached to the same enclosure wall as the passive radiator, or a different call (such as wall adjacent to or opposite of the wall on which the passive radiator is mounted). The enclosure of the audio system may be the mechanical ground of the lever arms.

In another aspect, a passive radiator assembly (suitable for mounting in an acoustic enclosure) includes a diaphragm, a flexible surround coupled to the diaphragm that permits movement of the diaphragm in response to pressure fluctuations in the enclosure, and a lever arm assembly. The lever arm assembly includes a fulcrum configured to be fixed to a mechanical ground, a lever arm attached to the diaphragm on a first side of the fulcrum and a mass coupled to the lever arm on the second side of the fulcrum.

In some implementations, the passive radiator assembly may include multiple lever arms, each have a fulcrum configured to attach to a mechanical ground on one side of the lever arm and a mass coupled to the opposite side of the lever arms. The multiple lever arms may be arranged to reduce rocking by the passive radiator (when compared with a passive radiator with no lever arms) and may be arranged to completely torque balance the passive radiator.

### BRIEF DESCRIPTION OF DRAWING

FIG. 1 is a front view of an enclosure with opposed drivers and a passive radiator;

FIGS. 2-3 are cut-away views of the enclosure of FIG. 1;

FIG. 4 is a front view of an enclosure with opposed drivers and a passive radiator;

FIGS. 5-6 are cut-away views of the enclosure of FIG. 4;

FIG. 7 is a front view of an enclosure with opposed drivers and a passive radiator;

FIGS. 8-9 are cut-away views of the enclosure of FIG. 7;

FIG. 10 is a front view of an enclosure with opposed drivers and a passive radiator;

FIGS. 11-12 are cut-away views of the enclosure of FIG. 10.

### DETAILED DESCRIPTION

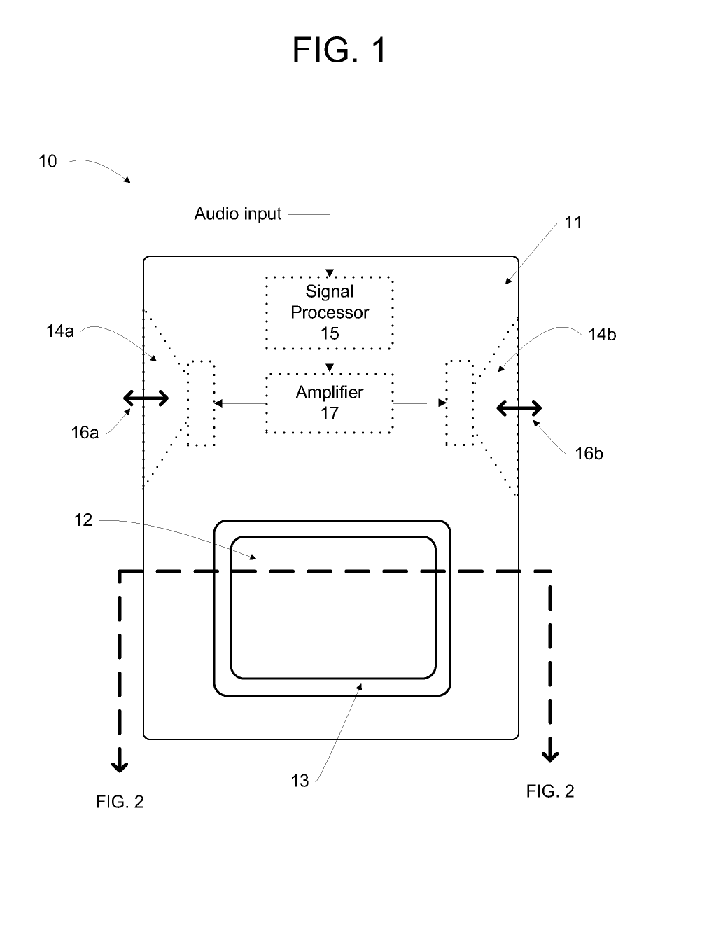

As shown in FIG. 1-3, a speaker system 10 includes passive radiator 12 which in this example is a rectangular-shape but may be other shapes such as round, elliptical, etc., and a pair of acoustic transducers 14a, 14b mounted on an enclosure 11 which encloses a volume of air. The pair of acoustic transducers 14a, 14b and the passive radiator 12 are in fluidic communication with the volume of air. The passive radiator 12 includes a suspension element 13 (e.g., a surround) that permits the passive radiator to move back and forth (i.e., into and out of the page as shown in FIG. 1). System 10 also includes a processor 15 that performs various signal processes on a received audio signal (e.g., audio decompression, equalization, digital-to-analog conversion, etc.) and an amplifier 17 that amplifies the processed audio signal and supplies it to the transducers 14a, 14b. Processor 15 and amplifier 17 may be located within enclosure 11, or they may be located external to enclosure 11 in electrical communication with transducers 14a and 14b.

Note that in this example, transducer 14a and transducer 14b receive the same signal. Thus, the two transducers will move symmetrically (as shown by arrows 16a, 16b). As the two transducers move together, their acoustic energy adds. However, since the transducers are mounted on opposite walls of the enclosure, their mechanical vibrations cancel—for example, as transducer 14a moves to the left as shown in FIG. 1 (i.e., away from the center of the enclosure), transducer 14b moves to the right (i.e., also away from the center of the enclosure). Reducing the mechanical vibration of the transducers (and other moving elements of the system 10) helps to prevent the system 10 from vibrating on the surface on which system 10 is placed. Reducing mechanical vibration also helps to prevent components (e.g., a speaker grill) in system 10 from squeaking, rattling, or making other unwanted noise. Should System 10 be attached to a larger system (such as a bass box attached to an automotive interior assembly) the reduced mechanical vibration would help to reduce unwanted buzz, squeak, and rattle noises.

System 10 also includes a passive radiator 12 that is acoustically coupled with the transducers 14a, 14b through the sealed volume of air within the enclosure. The design of passive radiator based loudspeaker systems is known, and will not be described in detail here. In brief, the passive radiator in conjunction with the volume of air contained in enclosure 11 forms a resonant system. A loudspeaker designer will choose a tuning frequency for this resonant system according to a design goal for the loudspeaker system. Once the designer has chosen a desired tuning frequency (the details of determining such a tuning frequency are known and will not be described), the area of the passive radiator diaphragm, the moving mass of the diaphragm assembly, the volume of the enclosure, and the compliance of the passive radiator suspension are determined. The tuning frequency is determined by the moving mass of the diaphragm (comprising the diaphragm physical mass and any associated acoustic mass of the air load on the passive radiator diaphragm), the effective mechanical compliance of the air in enclosure 11 (determined by the volume of enclosure 11 and the passive radiator diaphragm area), and the passive radiator suspension compliance.

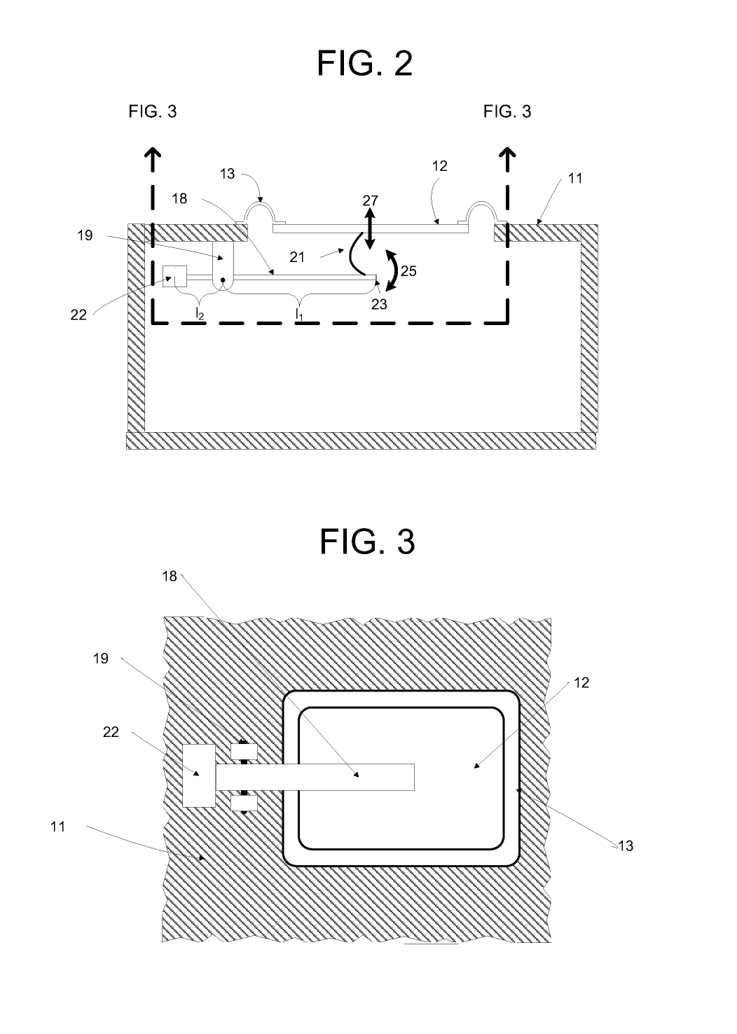

A lever arm 18 (shown in FIGS. 2-3) is mounted to the passive radiator 12 within the enclosure and serves to cancel inertial forces caused by movement of the passive radiator without significantly affecting the acoustic output of the passive radiator. More specifically, lever arm 18 is pivotally supported to the inside of the enclosure 11 at a fulcrum 19. The fulcrum 19 is mounted on a mechanical ground, which in this example is the inside surface of the enclosure 11 of system 10. The mechanical ground is intended—in this example—to remain relatively vibration-free as the passive radiator 12 (and other moving components such as the lever arm 18 and transducers 14a and 14b move). Note that by selecting the enclosure 11 as the mechanical ground, relatively little mechanical vibration is output by the system 10 to a table top or other surface on which the system sits.

One end of the lever arm 18 (i.e., the end near the tip 23 of the lever arm 18) is attached to the center of the inner surface of the passive radiator 12 with a coupling 21. At the opposite end of the lever arm a counter-balance mass 22 is mounted, which is selected such that it cancels the inertia of the moving passive radiator. Assuming the mass of the lever arm 18, coupling 21, and suspension element 13 are small in comparison to the mass of the passive radiator 12 and counter-balance mass 22, the total effective moving mass of the system M_{T} (i.e., the passive radiator 12, lever arm 18, and counterbalance mass 22) of a single-lever system can be expressed as follows:

M_{T}=M_{radiator}+(l₂/l₁)²*M_{counterbalance} (equation 1)

Where:
M_{radiator} is the mass of the passive radiator diaphragm 12,
M_{counterbalance} is the mass of the counter-balance mass 22,
l₁ is the length of the lever arm between the tip 23 attached to the passive radiator 12 and fulcrum 19, and
l₂ is the length of the lever arm between the fulcrum and the center of gravity of the counter-balance mass (see FIG. 2).
   To inertial balance the system, the mass of the passive radiator diaphragm (M_{radiator}) can be set as follows:

M_{radiator}=(l₂/l₁)²*M_{counterbalance} (equation 2)

Substituting equation 2 into equation 1, the following result is obtained:

M_{T}=M_{radiator}+M_{radiator}=2*M_{radiator},or

M_{radiator}=½*M_{T} (equation 3)

Thus, the moving mass of the passive radiator 12 can be set to ½ of the total desired effective moving mass (M_{T}) of the passive radiator assembly. The total effective moving mass (M_{T}) is the moving mass which along with the passive radiator suspension stiffness and stiffness due to the air in the box determines the resonance frequency of the passive radiator system.

The above analysis provides a useful simplification for understanding the behavior and relationships among system elements. If a designer wished to be more precise, the designer would also consider the effects of the lever arm masses, friction in the fulcrum pivot, stiffness of the coupling, stiffness of the lever arm, etc. in the system design. To consider these elements in the design, a finite element model of the complete mechanical system could be developed using commercially available software tools such as Abaqus Unified FEA, available from Dassault Systèmes of Vélizy-Villacoublay, France.

Additionally, one would also consider the fact that motion of the diaphragm is generally linear along a single axis, while motion of the compensating mass is arcuate. The component of the momentum of the compensating mass aligned with the axis of motion of the passive radiator diaphragm will be proportional to the cosine of the angle of displacement of its lever arm. For small angular displacements, the cosine is approximately equal to 1, and there is little error introduced by assuming the compensating mass moves linearly. As the angle of displacement of the lever arm increases, the cosine of the angle of decreases, the component of momentum of the compensating mass aligned with the axis of motion of the passive radiator diaphragm will decrease, and the relative momentums of the compensating mass and the moving mass of the passive radiator will no longer exactly offset each other. As such, it may be desirable for the system designer to choose compensating mass and lever arm segment lengths to obtain smaller angular displacements for a given passive radiator displacement. It may also be desirable, for system designs with larger angular displacement of the lever arms, for the compensating mass to be chosen such that it is slightly larger than ½ the desired tuning mass, and the moving mass of the passive radiator is chosen to be slightly less than ½ the tuning mass. This would sacrifice momentum cancellation for smaller angular displacements, but would improve it for larger angular displacements.

Using the above simplified equations, a system can be designed by first determining the total desired effective moving mass (M_{T}) of the passive radiator assembly, as discussed previously. Once M_{T} is determined, the mass of the passive radiator diaphragm can be set to be ½*M_{T} (equation 2), and then the counter-balance mass and lever arm lengths l₁ and l₂ can be selected using equation 2. Note that the magnitude of the counter-balance mass is effected by selection of lever arm lengths. Choosing a high-value lever arm ratio (i.e., l₂/l₁) will require a smaller counter-balance mass, but the counter-balance mass will travel a greater distance to counter-act vibration of the passive radiator. Conversely, choosing a low lever arm ration will require a larger counter-balance mass, but the counter-balance mass will travel a smaller distance to counter-act vibration of the passive radiator. It should be noted that the counterbalance mass and lever arm ratio need not be selected to exactly counterbalance the mass of the passive radiator 12. For example, the product lever arm ratio and passive radiator mass (i.e., l₁/l₂*M_{radiator},) may be selected to be slightly smaller (or even larger) than the mass of the passive radiator to cancel some (but not all) vibration produced by movement of the passive radiator 12.

Since the tip 23 of the lever arm 18 will move in an arc (illustrated by arrow 25 in FIG. 2) while the passive radiator moves in a linear motion (illustrated by arrow 27 in FIG. 2), the coupling 21 is preferably designed to accommodate this difference in the relative motion between the tip 23 of the lever arm and the passive radiator. In some implementations, a compliant coupling (e.g., a rubber coupling) can accommodate the difference in relative motion between the passive radiator and tip of the lever arm. If a compliant link is used, it is desirable to make it sufficiently stiff such that the resonance of the link's compliance when attached to the particular diaphragm is outside the operating frequency range of the passive radiator. In addition, the compliance should be such that the motion of the end of the lever arm attached to the flexure is in-phase (or approximately in-phase) with the motion of the diaphragm over the operating range of the passive radiator. Otherwise, the motion of the counter-balance mass will not properly cancel the inertia of the diaphragm moving mass.

In operation, as the passive radiator moves in one direction (e.g., outward from the center of the enclosure as shown in FIG. 1), the lever arm 18 pivots about the fulcrum 19 and moves the mass 22 in the opposite direction (e.g., inward toward the center of the enclosure as shown in FIG. 1). This serves to cancel the inertial forces caused by movement of the passive radiator and reduce vibration experienced by the system 10. Assuming the mass of the lever arm 19 and coupling 21 are small relative to the mass of the passive radiator 12 and there is a low friction pivot at the fulcrum 19, the acoustic output of the passive radiator is not significantly impeded by the lever arm 18 and counter-balance mass 22.

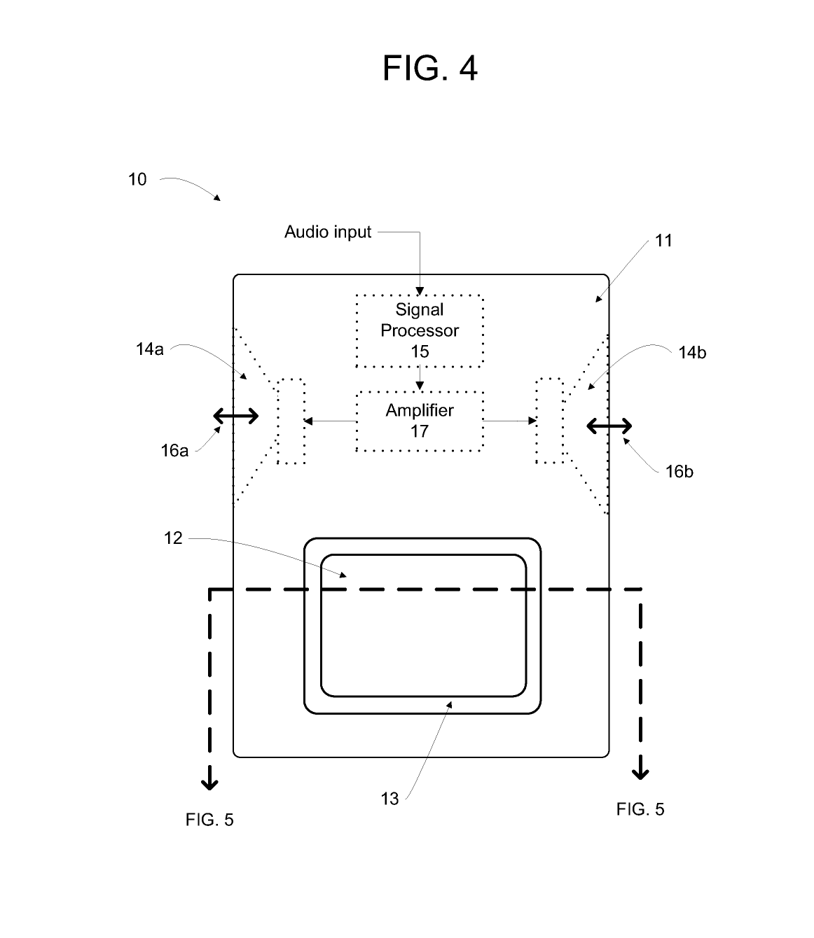

As shown in FIGS. 4-6, multiple lever arms are used to mass balance (like the system shown in FIGS. 1-3) as well as torque balance the passive radiator 12. In this example, two identical lever arms 18a, 18b are mechanically coupled to the passive radiator 12 via a coupling 21a, 21b. The couplings 21a, 21b should be designed to accommodate the relative difference in motion between the tip of the lever arms (which moves in an arc) and the passive radiator (which moves in a line).

Attached to each lever arm is identical compensating mass 22a, 22b. The mass elements 22a, 22b are selected to balance the mass of the passive radiator 12. Assuming the mass of the lever arms (18a, 18b), coupling (21a, 21b), and suspension element 13 are small in comparison to the mass of the passive radiator 12, the total effective moving mass of the system M_{T} (i.e., the passive radiator 12, lever arms 18a and 18b, and counterbalance masses 22a and 22b) of a double-lever system can be expressed as follows:

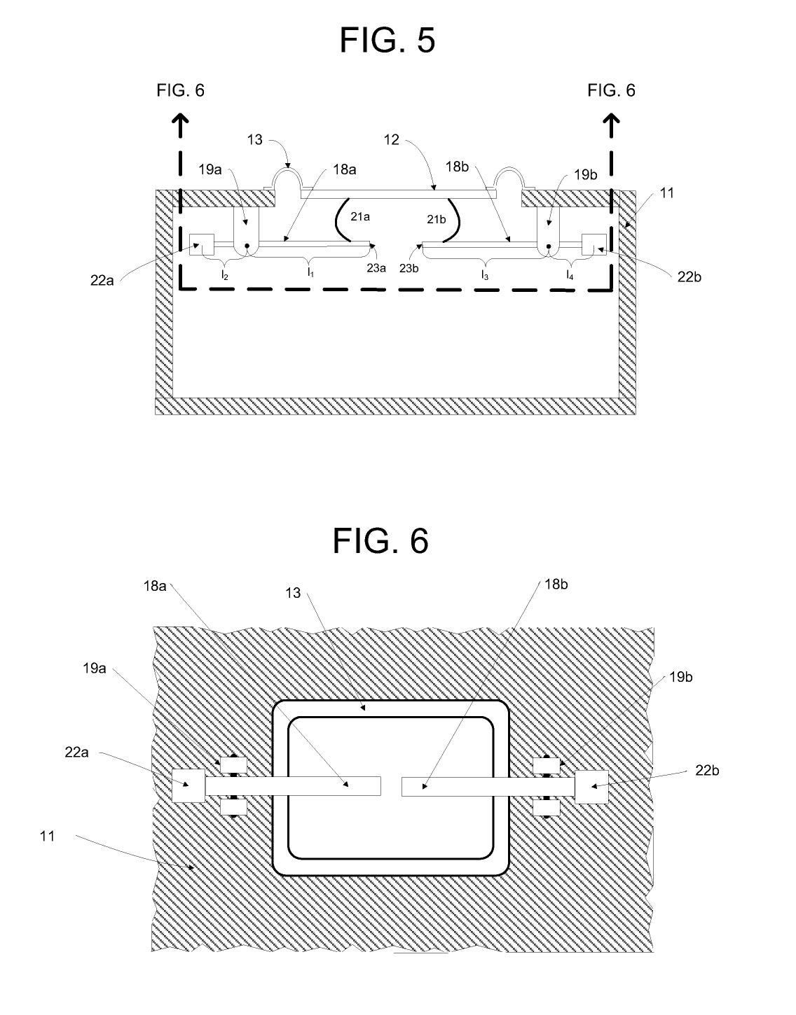

M_{T}=M_{radiator}+(l₂/l₁)²*M_{counterbalance}_{_{—}}₁+(l₄/l₃)²*M_{counterbalance}_{_{—}}₂ (equation 4)

Where:
M_{radiator} is the mass of the passive radiator diaphragm 12,
M_{counterbalance}_{_{—}}₁ is the mass of the counter-balance mass 22a of the first lever arm 18a,
l₁ is the length of the first lever arm 18a between the tip 23a attached to the passive radiator 12 and fulcrum 19a (see FIG. 5),
l₂ is the length of the first lever arm 18a between the fulcrum 19a and the center of gravity of the counter-balance mass 22a (see FIG. 5),
M_{counterbalance}_{_{—}}₂ is the mass of the counter-balance mass 22b of the second lever arm 18b,
l₃ is the length of the second lever arm 18b between the tip 23b attached to the passive radiator 12 and fulcrum 19b (see FIG. 5), and
l₄ is the length of the second lever arm 18b between the fulcrum 19b and the center of gravity of the counter-balance mass 22b (see FIG. 5).
   To inertial and torque balance the system shown in FIG. 5, the mass of the passive radiator diaphragm (M_{radiator}) and masses of the counterbalances and lever arm ratios can be set as follows:

M_{radiator}=(l₂/l₁)²*M_{counterbalance}_{_{—}}₁+(l₄/l₃)²*M_{counterbalance}_{_{—}}₂,AND (equation 5)

(l₂/l₁)²*M_{counterbalance}_{_{—}}₁+(l₄/l₃)²*M_{counterbalance}_{_{—}}₂=M_{ceff} (equation 6)

Where M_{ceff} is the effective compensation mass of the lever arm assemblies 18a, 18b.

Substituting equation 5 into equation 4, the following result is obtained:

M_{T}=M_{radiator}+M_{radiator}=2*M_{radiator},or

M_{radiator}=½*M_{T} (equation 7)

Note that equation 7 yields the same result as equation 3 in the single lever arm system. Thus, the moving mass of the passive radiator 12 can be set to ½ of the total effective moving mass (M_{T}) of the passive radiator assembly.

In equation 6, the effective compensation mass (M_{ceff}) of the lever arms 18a, 18b is introduced. Substituting this term into equation 5 yields:

M_{radiator}=M_{ceff}+M_{ceff}=2*M_{ceff} (equation 8)

Substituting equations 6 and 8 into equation 4 yields the following:

M_{T}=2*M_{ceff}+M_{ceff}+M_{ceff}=4*M_{ceff},or (equation 9)

M_{ceff}=¼*M_{T} (equation 10)

To solve for the compensation masses 22a, 22b and lever arm ratios for the lever arms 18a, 18b, substitute equation 10 into equation 6, which yields:

¼*M_{T}=(l₂/l₁)₂*M_{counterbalance}_{_{—}}₁=(l₄/l₃)²*M_{counterbalance}_{_{—}}₂ (equation 11)

Note that selection of the counterbalance masses 22a, 22b is not unique since their magnitude is effected by selection of the lever arm ratios. Note, also, that the counter-balance masses and lever arm ratios can be different for each lever arm assembly, even if their resulting products are the same, although use of different lever arm segment lengths will result in different angular displacements which can cause the component of momentum in the direction of motion of the passive radiator diaphragm of each counterbalance mass to vary with respect to each other as a function of angular displacement. Note also that while equations 4-11 are for a two lever-arm system, these equations are readily extendible to any multi-arm system by simply adding terms like (l₂/l₁)²*M_{counterbalance}_{_{—}}₁ to equation 4.

Using the above equations, a multi-lever arm system can be designed by first determining the total desired effective moving mass (M_{T}) of the passive radiator assembly, areas discussed previously. Once M_{T} is determined, the mass of the passive radiator diaphragm can be set to be ½*M_{T} (equation 7), and then the counter-balance masses 22a, 22b, etc. and lever arm lengths l₁, l₂, l₃, l₄, etc. can be selected using equations 5 and 6 or equation 11.

In operation, the masses 22a, 22b move in an opposite direction as the passive radiator diaphragm 12 and, since they are selected to balance the mass of the passive radiator, they cancel much of the mechanical vibration experienced by the system 10 caused by movement of the passive radiator 12. In addition, use of multiple lever arms arranged symmetrically along the rear surface of the passive radiator helps to keep the passive radiator torque balanced. In other words, the two lever arms shown in FIGS. 4-6 serve to reduce rocking that might be experienced by the passive radiator at certain frequencies of operation.

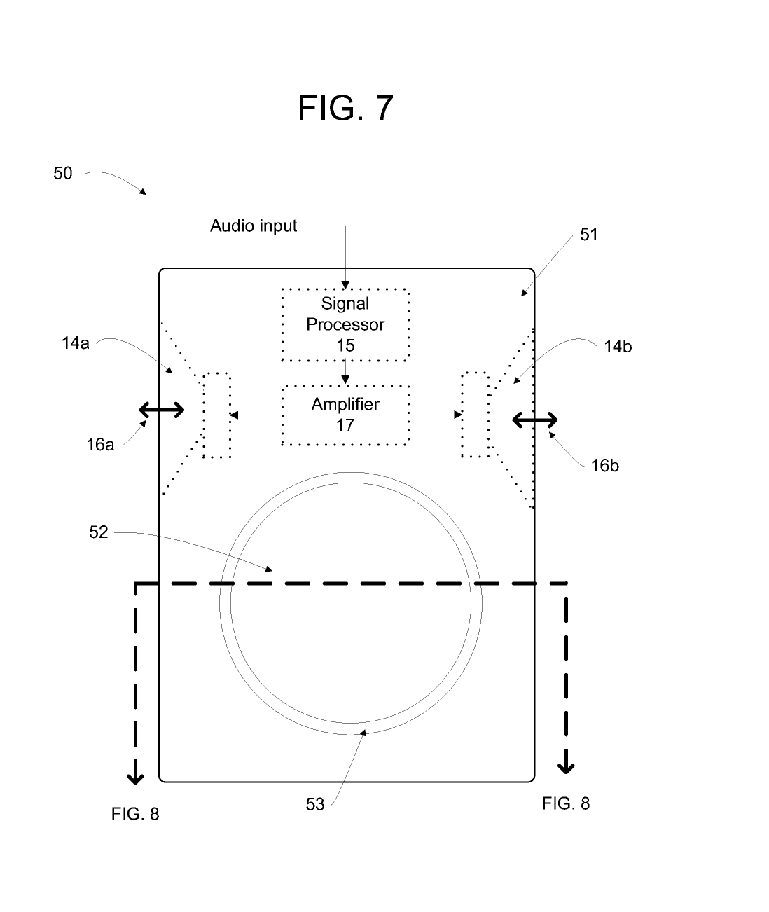

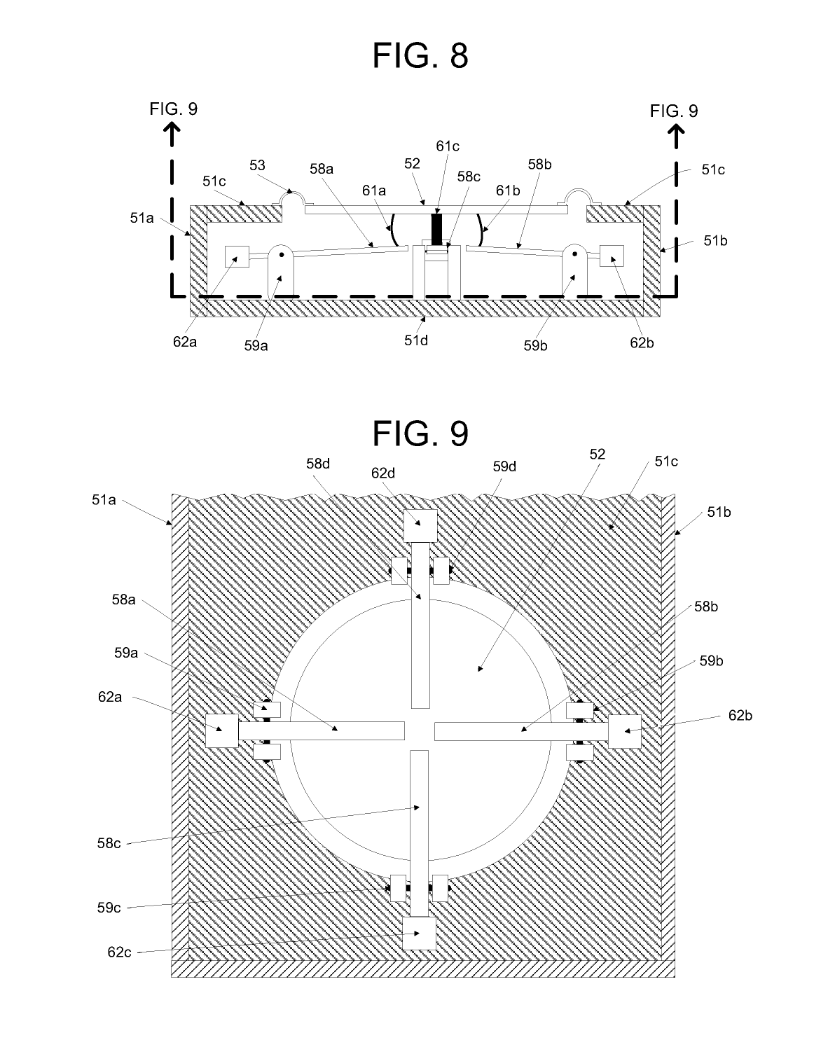

In some implementations, three or more lever arms may be used to mass balance and/or torque balance the passive radiator. Additionally, the lever arms may be attached within the enclosure at various attachment points to accommodate different packaging arrangements. For example, as shown in FIGS. 7-9, a system 50 uses four lever arms 58a-58d to mass and torque balance a circular-shaped passive radiator 52. In addition, the fulcrum 59a-59d of each lever arm are attached to a wall 51d of the enclosure opposite of the wall 51c in which the passive radiator 52 is mounted. (Note that in FIGS. 1-6 the fulcrums of the lever arms are mounted on the same enclosure wall as the passive radiator). The system 50 shown in FIGS. 7-9 include similar elements as described in previous embodiments including a signal processor 15, amplifier 17 and a pair of transducers 14a, 14b that are configured such that their acoustic energy generally adds while their mechanical vibrations generally cancel.

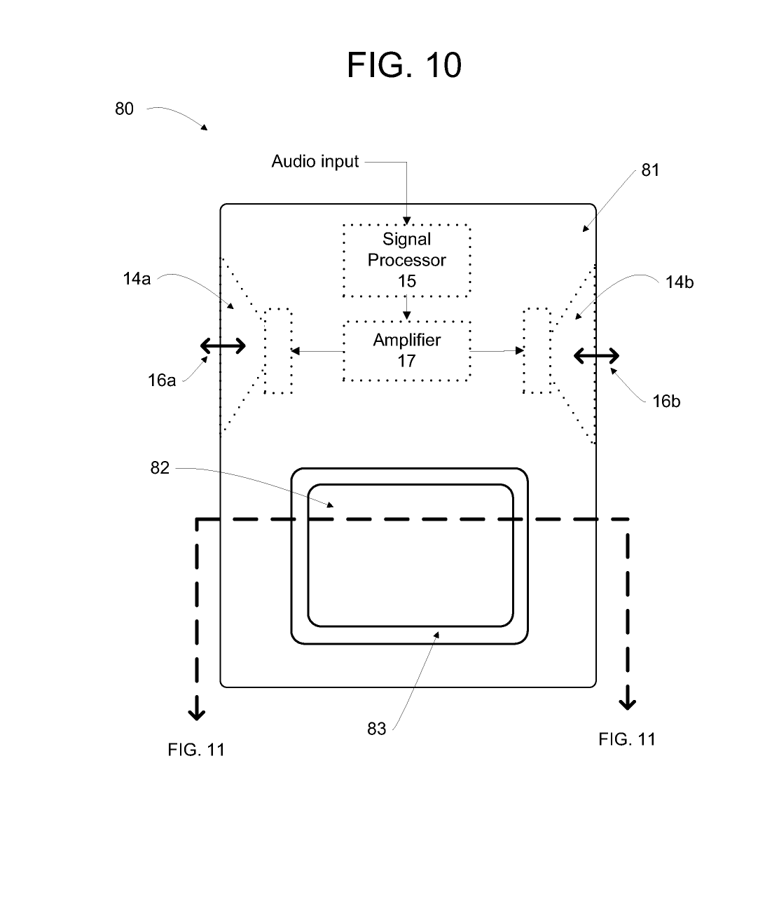

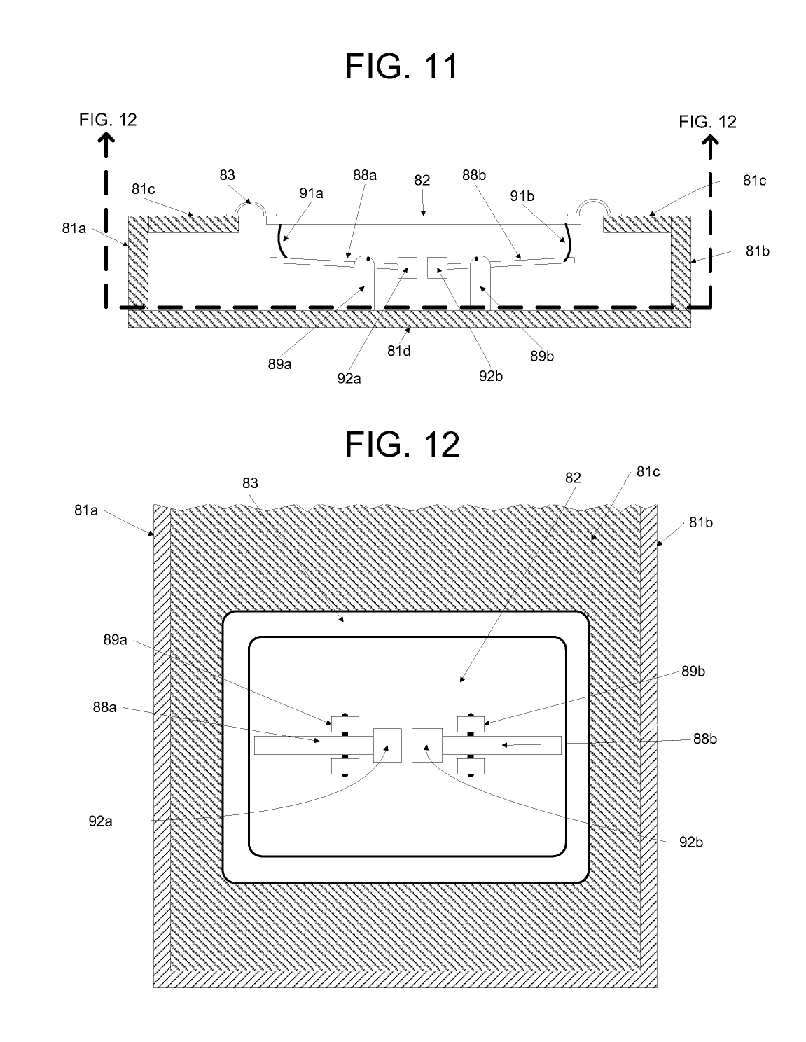

The lever arms may also be mounted such that they are mounted in-board of the perimeter of passive radiator. For example, as shown in FIGS. 10-12, a system 80 includes a pair of lever arms 88a, 88b mounted within the perimeter of a passive radiator 82. More specifically, lever arms 88a, 88b are mounted to the inner surface of the rear wall 81d of the enclosure 81. As in other embodiments, each lever arm includes a coupling (91a, 91b), fulcrum (89a, 89b), and counter-balance mass (92a, 92b). The counter-balance masses 92a, 92b are selected to cancel inertial forces generated by the moving passive radiator 82. The enclosure 81 serves as the mechanical ground, and since the enclosure 81 is in direct contact with the surface on which system 80 sits, few mechanical vibrations are transmitted from system 80 to its supporting surface. The arrangement of the lever arms in this embodiment also provides some resistance to rocking of the passive radiator 82. In other implementations, additional lever arms may be used to provide further resistance to rocking (including fully-torque balancing the passive radiator like what is shown in FIGS. 7-9) and also cancel inertial forces generated by the moving passive radiator.

There has been described novel apparatus and techniques for reducing vibration of a driver enclosure through counteracting force and rocking of a passive radiator. It is evident that those skilled in the art may now make numerous uses and modifications of and departures these specific apparatus and techniques herein disclosed without departing from the inventive concepts. Consequently, the invention is to be construed as embracing each and every novel feature and each and every novel combination of features present at in or possessed by the apparatus and techniques herein disclosed and limited solely by the spirit and scope of the appended claims.

What is claimed is:

1. An audio system comprising:
an enclosure enclosing a volume of air;
a passive radiator mounted to the enclosure and in fluid communication with the volume of air;
a fulcrum fixed to a mechanical ground;
a lever arm attached to the passive radiator on a first side of the fulcrum, the lever arm having a mass coupled to it on a second side of the fulcrum, wherein the lever arm and its mass are configured to move with the passive radiator such that movement of the lever arm and its mass reduce a level of vibration transmitted to the mechanical ground caused by movement of the passive radiator when compared with the level of vibration transmitted to the mechanical ground by movement of the passive radiator without the operation of the lever arm and its mass.

2. The audio system of claim 1, wherein the enclosure comprises the mechanical ground.

3. The audio system of claim 1, further comprising:
a second fulcrum fixed to the mechanical ground;
a second lever arm attached to the passive radiator on a first side of the second fulcrum, the second lever arm having a mass coupled to it on a second side of the second fulcrum, wherein both the first and second lever arms and their masses are configured to move along with the passive radiator such that movement of the lever arms and their masses reduce a level of vibration transmitted to the mechanical ground caused by movement of the passive radiator when compared with the level of vibration transmitted to the mechanical ground by movement of the passive radiator without the operation of the lever arms and their masses.

4. The audio system of claim 3, wherein the first and second lever arms also provide a greater resistance to rocking by the passive radiator when compared with the passive radiator without operation of the lever arms and their masses.

5. The audio system of claim 4, wherein the enclosure comprises the mechanical ground.

6. The audio system of claim 1, wherein the enclosure comprises a first wall having an inner surface and an outer surface, and the passive radiator is mounted within an opening in the first wall and the fulcrum is fixed to the inner surface of the first wall.

7. The audio system of claim 1, wherein the enclosure comprises:
a first wall having an inner surface and an outer surface; and
a second wall having an inner surface and an outer surface, the second wall parallel to the first wall, and
wherein the passive radiator is mounted within an opening in the first wall and the fulcrum is attached to the inner surface of the second wall.

8. The audio system of claim 1, further comprising:
a first transducer for producing acoustic energy from an electrical signal, the first transducer mounted to the enclosure and in fluid communication with the volume of air.

9. The audio system of claim 8, further comprising:
a second transducer for producing acoustic energy from the same electrical signal as the first transducer, the second transducer mounted to the enclosure and in fluid communication with the volume of air, wherein the first and second transducers are mounted on the enclosure such that the acoustic energy they output into the volume of air adds while the mechanical vibrations transmitted by the transducers into the enclosure subtract.

10. The audio system of claim 1, further comprising:
a coupling that attaches the passive radiator to the lever arm.

11. The audio system of claim 1, wherein the coupling is a compliant coupling.

12. An audio system comprising:
an enclosure enclosing a volume of air;
a passive radiator mounted to the enclosure and in fluid communication with the volume of air;
a plurality of lever arms coupled to the passive radiator at a first end of each lever arm, wherein each lever arm is pivotally attached to a fulcrum and each of the fulcrums are attached to a mechanical ground,
wherein each lever arm includes a mass on the side of the fulcrum that is opposite the side on which the lever arm is attached to the passive radiator, wherein the lever arms are configured to move the masses out of phase with movement of the passive radiator.

13. The audio system of claim 12, wherein the plurality of lever arms are arranged to torque balance the passive radiator.

14. The audio system of claim 12, wherein the plurality of lever arms are attached symmetrically around a surface of the passive radiator.

15. The audio system of claim 12, wherein the plurality of lever arms also provide a greater resistance to rocking by the passive radiator when compared with the passive radiator without operation of the lever arms and their masses.

16. The audio system of claim 12, wherein movement of the plurality of lever arms reduce a level of vibration transmitted to the mechanical ground caused by movement of the passive radiator when compared with the level of vibration transmitted to the mechanical ground by movement of the passive radiator without the operation of the lever arms and their masses.

17. The audio system of claim 12, wherein the enclosure comprises the mechanical ground.

18. The audio system of claim 12, wherein the enclosure comprises a first wall having an inner surface and an outer surface, and the passive radiator is mounted within an opening in the first wall and the fulcrum of each of the plurality of lever arms is fixed to the inner surface of the first wall.

19. The audio system of claim 12, wherein the enclosure comprises:
a first wall having an inner surface and an outer surface; and
a second wall having an inner surface and an outer surface, the second wall parallel to the first wall, and
wherein the passive radiator is mounted within an opening in the first wall and the fulcrum of each of the plurality of lever arms is attached to the inner surface of the second wall.

20. The audio system of claim 12, wherein the enclosure comprises a first wall having an inner surface and an outer surface, and the passive radiator is mounted within an opening in the first wall and the fulcrum at least one of the plurality of lever arms is fixed to the inner surface of the first wall.

21. The audio system of claim 12, wherein the enclosure comprises:
a first wall having an inner surface and an outer surface; and
a second wall having an inner surface and an outer surface, the second wall parallel to the first wall, and
wherein the passive radiator is mounted within an opening in the first wall and the fulcrum of at least one of the lever arms is attached to the inner surface of the second wall.

22. The audio system of claim 12, further comprising:
a first transducer for producing acoustic energy from an electrical signal, the first transducer mounted to the enclosure and in fluid communication with the volume of air.

23. The audio system of claim 22, further comprising:
a second transducer for producing acoustic energy from the same electrical signal as the first transducer, the second transducer mounted to the enclosure and in fluid communication with the volume of air, wherein the first and second transducers are mounted on the enclosure such that the acoustic energy they output into the volume of air adds while the mechanical vibrations transmitted by the transducers into the enclosure subtract.

24. The audio system of claim 12, further comprising a plurality of couplings, each coupling attaching a lever arm to the passive radiator.

25. A passive radiator assembly configured to mount in an acoustic enclosure, the passive radiator assembly comprising:
a diaphragm;
a flexible surround coupled to the diaphragm, wherein the surround permits movement of the diaphragm in response to pressure fluctuations in the enclosure;
a lever arm assembly comprising:
a fulcrum configured to be fixed to a mechanical ground;
a lever arm attached to the diaphragm on a first side of the fulcrum, the lever arm having a mass coupled to it on a second side of the fulcrum, wherein the lever arm is configured to move the mass out of phase with movement of the diaphragm.

26. The passive radiator assembly of claim 25 further comprising:
a second lever arm assembly comprising:
a second fulcrum fixed to the mechanical ground;
a second lever arm attached to the diaphragm on a first side of the second fulcrum, the second lever arm having a second mass coupled to it on a second side of the second fulcrum, wherein the lever arm is configured to move the second mass out of phase with movement of the diaphragm.

27. The passive radiator assembly of claim 26, wherein the first and second lever arms also provide a greater resistance to rocking by the passive radiator when compared with the passive radiator without operation of the lever arms and their masses.

28. The passive radiator assembly of claim 25 wherein the mechanical ground is the enclosure.

29. The passive radiator assembly of claim 25 further comprising a plurality of lever arm assemblies, each lever arm assembly comprising (i) a fulcrum fixed to a mechanical ground; and (ii) a lever arm attached to the diaphragm on a first side of the fulcrum, the lever arm having a mass coupled to it on a second side of the fulcrum, wherein the lever arm is configured to move the mass out of phase with movement of the diaphragm.

30. The passive radiator assembly of claim 29 wherein the plurality of lever arms are arranged to torque balance the passive radiator.
